(19) United States
(12) Patent Application Publication
(10) Pub. No.: US 2024/0076055 A1
(43) Pub. Date: Mar. 7, 2024

(54) FlightSearch - A Search, Analysis and Summarization Methodology for Signal Data Composed of Time Series

(71) Applicant: EMBRAER S.A., São José dos Campos - SP (BR)

(72) Inventors: Mateus Soares RODRIGUES, São José dos Campos - SP (BR); Cleverson Maranhão Porto MARINHO, São José dos Campos - SP (BR); João Flavio Reis NEGRETI, São José dos Campos - SP (BR); Felipe Marcenes KAMEI, São José dos Campos - SP (BR); Marco Aurelio Guimarães MOREIRA, São José dos Campos - SP (BR); Carlos Eduardo Tancredo MUSSI, São José dos Campos - SP (BR); Juliano Augusto DE BONFIM GRIPP, São José dos Campos - SP (BR); Guilherme Sousa VILAÇA, São José dos Campos - SP (BR)

(21) Appl. No.: 18/243,043

(22) Filed: Sep. 6, 2023

Related U.S. Application Data
(60) Provisional application No. 63/374,739, filed on Sep. 6, 2022.

(51) Int. Cl. B64D 45/00; G06F 9/54

(52) U.S. Cl. CPC B64D 45/00; G06F 9/542

(57) ABSTRACT

A system and method for collecting and analyzing time sequences of signal data produced by a product development effort including but not limited to aircraft signals. A time sequence signal data analyzer receives a signal event specification, searches time sequenced signal data for time slices that meet the signal event specification, analyzes a located time slice that meets the event specification to determine if it satisfies a criterion; and generates a data structure that (a) indicates a portion of the time sequenced signal data that meets the signal event specification and (b) indicates whether or not the portion of the time sequenced signal data that meets the event specification satisfies the analysis criterion or criteria.

### CROSS-REFERENCE TO RELATED APPLICATIONS

Priority is claimed from U.S. provisional patent application No. 63/374,739 filed Sep. 6, 2022, incorporated herein by reference.

### FIELD

The technology herein relates to analyzing time series signals including but not limited to from aircraft, and to allowing the user to specify the desired search and analysis easily, using regular expression, without the knowledge of computer programing languages. For exemplification's sake, the methodology can be used on data obtained from simulation, tests or final product measurements of airplanes, cars, boats, or spaceships. The technology herein provides a versatile and powerful way to analyze signal data recorded as a time series from any data source (aircrafts, cars, ships, stock price, etc).

### BACKGROUND & SUMMARY

In recent years, general product development engineering has become more model based and data driven. The product design usually starts with simulations done on each engineer's personal computer, evolves for testing each component in isolation in the laboratory or test bench (hardware in the loop) and ends on testing the integration of all the components on a prototype of the final product.

In each of the described stages of development, a huge amount of data is generated. Most of this data is composed of time series, i.e. a series of values of a quantity obtained at successive times, often with equal intervals between them, representing the changing value of a signal over time.

The aircraft development engineering is especially affected by such massive accumulation of data. A modern military or commercial aircraft has several hundred computers, sensors and bus signals that work together to build up all the necessary systems. Each of these individual equipment units by itself generates several hundred to thousands of time series with each time series being sampled several times per second. Even a single aircraft flight test that records data from many sensors and systems monitoring can by itself generate and record massive quantities of time series data. See e.g., Zhang et al, “Time Series Analysis Methods and Applications for Flight Data” (Springer 2017).

For example, an airborne automatic flight data recording system generally acquires (e.g., periodically samples) many discrete signal data streams comprising continuous parameters from many different airborne sensors and also acquires digital data streams from airborne digital sensors and other airborne data sources. While previous generations of flight recorders recorded time series signal data streams on different magnetic tape tracks or even on different chart paper traces, modern flight data recorders are solid state and digitally record signal data streams received from data busses and other data sources into a solid state memory. Such signal data streams (along with a cockpit voice stream) are automatically recorded by the crash-protected flight recorder system for the entire duration of the flight from a time before the flight begins to a time after the flight ends (see e.g., 14 CFR § 91.609). Generally, each parameter is recorded a few times per second, although some units store “bursts” of data at a much higher frequencies if the data begin to change quickly. Current FAA regulations require certain specific parameters to be recorded: relative time, indicated airspeed, altitude and altitude rate, magnetic heading, vertical and longitudinal accelerations, pitch and roll attitudes, stabilizer trim or other pitch control position, engine power for each engine, angle of attack, flap positions, thrust reverser, spoiler/speedbrake, and autopilot engaged/disengaged. See 14 CFR § 91.609 Appendix E. Some flight recorder systems monitor these and additional parameters and test flight data recorders may acquire and record even more data. Some recorded parameters are sensed by one or more sensors, other recorded parameters may be processed by airborne systems, and other parameters reflect the state(s) of an airborne system such as wheels on ground. Thus, these time series do not come from sensors alone.

Without a tool that implements a proper methodology to navigate through this data, the effort of the product development engineer can be herculean. A good analogy for the issue is trying to navigate on the internet without a search engine.

### BRIEF DESCRIPTION OF THE DRAWINGS

FIG. 1 shows an example data collection and analysis architecture.

FIG. 1A shows an example overall time series data collection and analysis system.

FIG. 1B shows example time sequence signal data streams collected from an aircraft as one one-limiting example.

FIG. 1C shows an example high level flow chart.

FIG. 2 shows an example interface.

FIG. 3 shows examples of searched events in the time series including some example user interfaces for filling in the requested fields on the interface for the search stage.

FIG. 4 shows an example user interface for enabling users to fill the analysis fields on the interface.

FIG. 5 shows an example table generated at the analysis stage and is transported to a spreadsheet file with the user specified criteria used to color or shade the cells containing the results of the equations and images containing plots of specified parameters curves of each found event.

FIGS. 6A and 6B show example plots of the signals of interest.

FIGS. 7A and 7B show an example sequence of operations performed by a computing machine that is part of the FIG. 1A system.

### DETAILED DESCRIPTION OF NON-LIMITING EMBODIMENTS

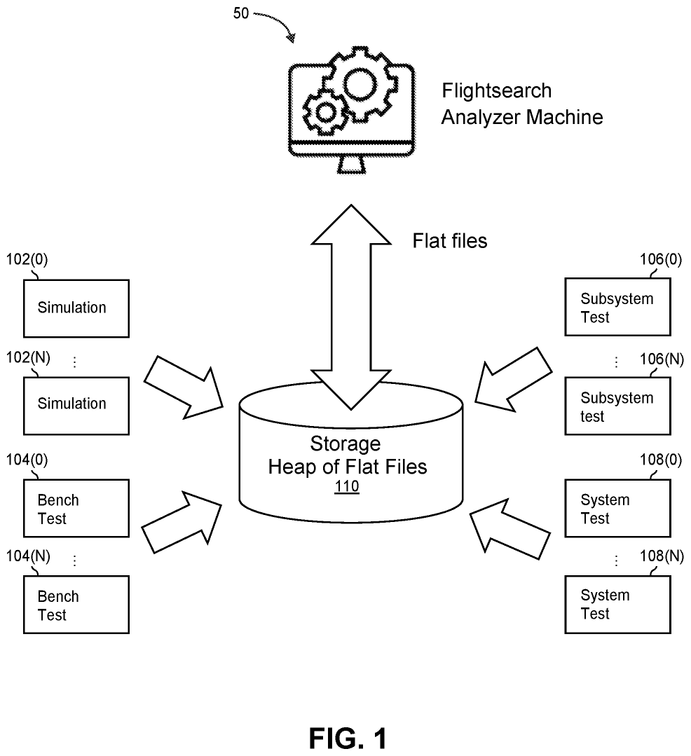

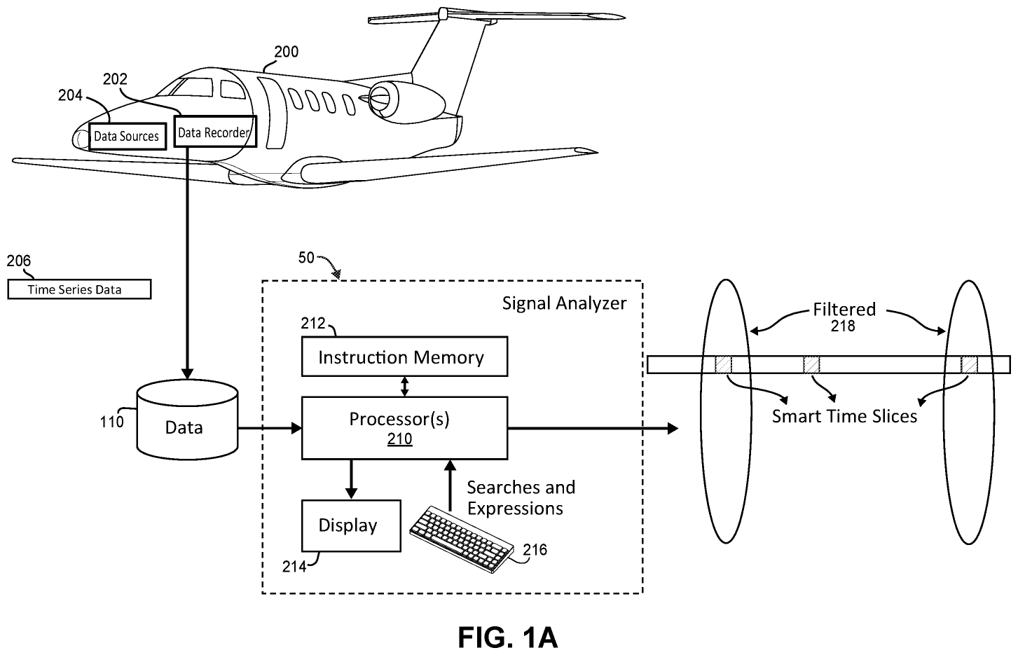

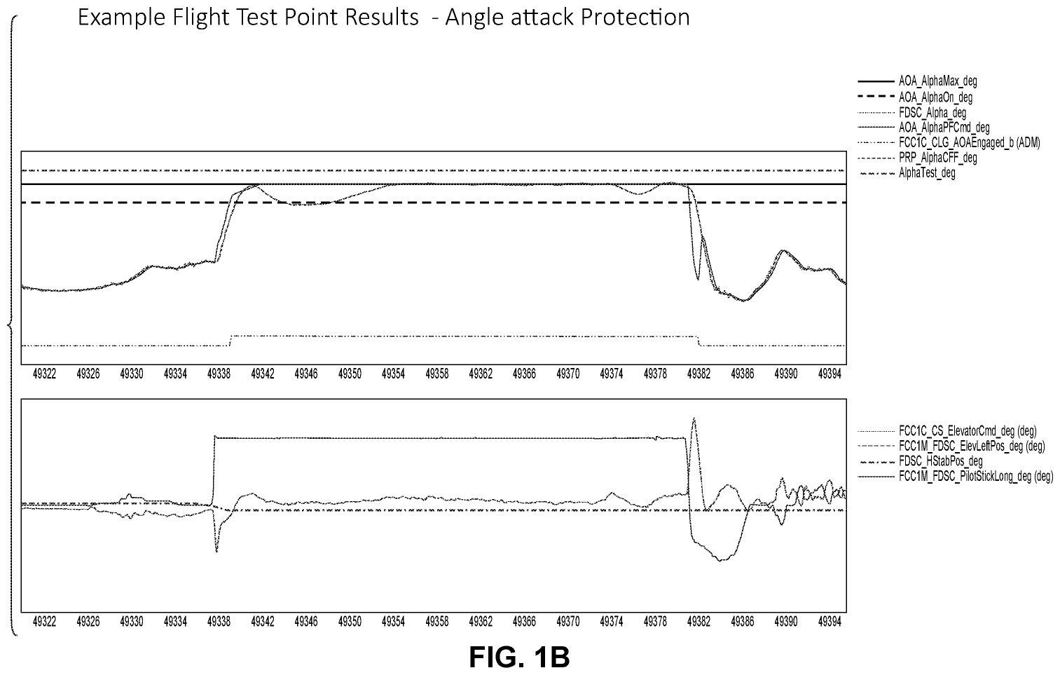

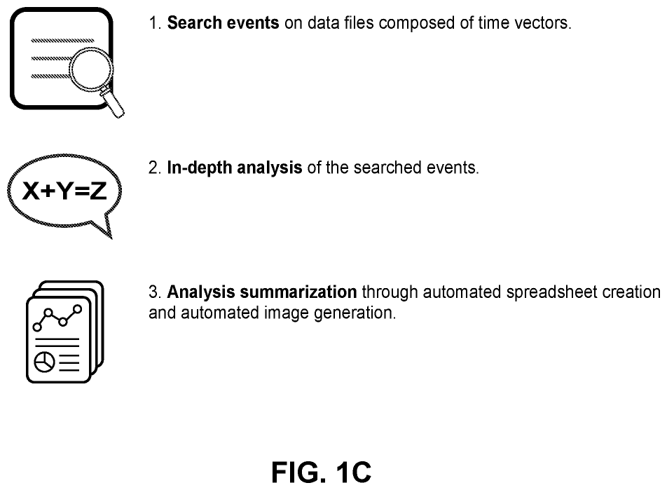

FIG. 1 shows an example data collection and analysis architecture that produces testing data for various phases of a development project. In the example shown, simulations 102 running on for example computing systems may generate output data such as test parameters and associated results that are stored in storage 110. Such simulations 102 can be used in early phases of the development project but can also be used later on when more concrete configuration data is known.

Once prototypes or components have been constructed, they can be bench tested and data may be collected manually, by test instruments and/or by sensors. Such collected data can be reported to storage 110.

In further phases of development, subsystems can be integrated together and tested. Test results and testing parameters can be reported to storage 110.

In later phases of development, subsystems can be integrated into systems that can be tested as a whole. The result of such system tests can be reported to storage 110.

The particular nature of the time sequence data streams that are collected depend on the component, system or subsystem being monitored. Some data streams may be analog time-varying signals produced by sensors that are then sampled at appropriate Nyquist frequencies and digitized to provide a digital data stream. Other data streams may be produced by various digital data sources including digital monitoring systems, digital sensors such as shaft encoders, gyrosensors, accelerometers, control inputs, etc., or any other digital data source that produces a time varying signal. Many different kinds of time sequence data streams from many different kinds of data sources can be employed including for example simulators that synthesize data streams. See e.g., Shy et al, The Role of Aircraft Simulation in Improving Flight Safety Through Control Training, NASA/TM-2002-210731 (NASA 2002); H. Sagirkaya et al, “Avionics Simulation Environment,” 2020 IEEE International Test Conference (ITC), Washington, DC, USA, 2020, pp. 1-3, doi: 10.1109/ITC44778.2020.9325215.

In many cases, the data streams are reported in flat files such as .txt, .csv, .tsv, .hdf5, feather, and the like. Different tests and processes can report data in different formats. The data can be communicated to the data storage 110 in a variety of different ways such as direct entry, wireless transmission, transmission over a wired or wireless network, etc. In some embodiments, storage 110 stores the data reported to it as a heap and does not attempt to index the data.

As one example, assume the system is an aircraft comprising thousands of components. Each component may be simulated by a simulation 102, and then prototyped to provide test bench results 104. The components may be integrated into subsystems such as an avionics system, an engine or propulsion system, an environmental control system, etc. There may be many different hierarchical levels of such subsystems (for example, a propulsion system may comprise individual engines; an environmental control system may comprise a bleed air subsystem, an air pressurization subsystem, a temperature control system, etc.; and so on). Each such subsystem may be tested individually at 106 before being integrated into an overall aircraft system test 108. The aircraft system test 108 can be of different types including for example test flights.

Such testing in different phases can thus extend over the course of months or years and may involve thousands or tens of thousands of individual tests performed at different times and places by different people implementing different processes to provide vast amounts of data in many different formats.

FIG. 1 shows a signal data analyzer 50 (which may comprise a computing or data processing system including one or many processors, memory, input/output devices, etc.) that access and analyze the time series data stored by storage 110.

FIG. 1A shows an example aircraft 200 comprising a flight data recorder 202 that records flight data from airborne data sources 204 including but not limited to the parameters required by FAA regulations. The recorded time series data 206 is communicated (e.g., downloaded) from the onboard data recorder 202 to data storage 110 as described above. A data analysis system 50 accesses and analyzes the time series data stored by the data storage 110. In this example, the data analysis system 50 includes one or many processors 210 such as multicore microprocessors, processing circuits, graphics processing units including parallel compute cores, or the like, as well known in the art. The processor(s) 210 are connected to an instruction memory 212 that stores instructions the processor(s) 210 executes to perform the algorithms and instructions described herein. The processor(s) 210 provides a user interface including one or more input device(s) 216 that receive inputs specifying searches and expressions from a user and provide output displays on a display device 214. The processor(s) 210 may also be connected to one or more networks (not shown) to communicate with other processors. In one example, the processor(s) 210 may be remotely located from the user(s) and communicate with a user(s) over such network(s) via a web based or other interface. The processor(s) 210 generate or define, in one embodiment, smart time slices that can be further tested based on expressions, as described herein.

FIG. 1B shows a non-limiting example of signal data streams that can be analyzed by signal data analyzer 50. In this particular non-limiting example, the signal data comprises signals relating to angle of attack protection of an aircraft including the following mostly angle-based signals:
AOA_AlphaMax_deg: max alpha [deg] commanded.
AOA_AlphaOn_deg: alpha [deg] threshold of protection engagement.
FDSC_Apha_deg: alpha [deg] voted.
AOA_AlphaPFCmd_deg: alpha [deg] commanded by pilot.
FCC1C_CLG_AOAEngaged_b: Boolean indicating that the protection is engaged.
PRP_AlphaCF_deg: filtered alpha [deg].
AlphaTest_deg: max alpha [deg] already tested
FCC1_CS_ElevatorCmd_deg: elevator position [deg] commanded.
FCC1M_FDSC_ElevLeftPos_deg: left elevator position [deg].
FDSC_HStabPos_deg: horizontal stab position [deg].
FCC1M_FDCS_PilotStickLong_deg: pilot stick longitudinal deflection angle [deg].

Some of these signals may be produced or derived from sensors such as control surface position and/or orientation detectors, other signals may represent command/control signals to control surface actuators or other components, other signals may be produced based on user inputs such as pilot sticks, other signals may represent state of the flight control computer (e.g., angle of attack protection engaged), etc. Some signals may be sampled analog signals produced by sensors or other signal sources, other signals may be produced by digital sensors or other digital data sources, still other signals may be produced by processors that analyze ones or combinations of the above signals, still other signals may be Boolean signals indicating system state, etc. The various signals are presented for illustration purposes on 2D graphs against an abscissa providing progressively increasing time coordinates such as 49322, 49326, etc. describing a series of time instants (earlier in time is to the left, later in time is to the right). The graphs show various time varying signals relative to a common ordinate (angle or degree) axis for purpose of illustration but one skilled in the art will understand that different kinds of signals may vary based on amplitude or magnitude as well as angle or phase. This is just one non-limiting example for purposes of illustration—there are many ossibilities.

The effort to navigate and analyze this and other signal data can be divided in three basic stages (see FIG. 1C):
Search on the databank files the pieces of data that correspond to specific events of interest of an engineer on a certain task
Run Analysis of the events of interest found in the search
Summarization of the analysis results through table and images such as automated spreadsheet creation and automated image generation.

Most of the commercially available software to search databases perform such tasks on SQL (relational) databases. However, relational databases are not often used to store time series due to scalability problems. NoSQL (non-relational databases) as Amazon's DynamoDB (see e.g., U.S. Pat. No. 8,965,849) and MongoDB, are beginning to be used as a scalable alternative to storing time series data. However, they present two problems:
They need a complex infrastructure to ingest, store and maintain time series data that are usually recorded on the its origin as a flat file (.txt, .csv, .tsv, .hdf5, feather.)
They need multiple auxiliary software to read, manipulate, and plot the data contained on it.

Having this in mind, aspects of the technology herein relate to an unique computer-implemented methodology capable of performing in an integrated manner a search, analysis and summarization on time series data stored directly in a bundle of the abovementioned flat files. In one embodiment, a user can search through a massive collection of time-sequenced flat file test results to locate particular stored data time sequences bracketed by particular start and end events or combinations of events. The system will retrieve time slices of data files that satisfy the particular specified event window(s). The user can also input analysis equations and results to further condition search results.

The technology here described “FlightSearch—A Search, Analysis and Summarization computer-implemented methodology for signal data composed of time series” provides integration of a time series search engine, an analysis platform and summarization algorithms. Flight Search was not created to perform a specific type of search or analysis on the data, but to allow the user to specify the desired search and analysis easily, using regular expression, without the knowledge of computer programming languages.

Therefore, the methodology is extremely flexible to attend to every engineer need, allowing the specification of any data temporal pattern (involving any quantity of time series) that defines the event of interest and the specification of any equations that constitutes analysis that needs to be done on the event. The methodology provides a computer-implemented infrastructure that increases engineer productivity on dealing with huge flat file data banks.

FlightSearch is able to search on several files format: .csv, .txt, .tsv and hdf5, but several other formats that can store time series can be easily added. The methodology is not dependent on the file format, and example embodiments can operate on any kind of flat file.

Moreover, the technology herein implements the methodology in an algorithm and a graphical interface is created to facilitate engineer interaction with the algorithm without the need of programming language understanding.

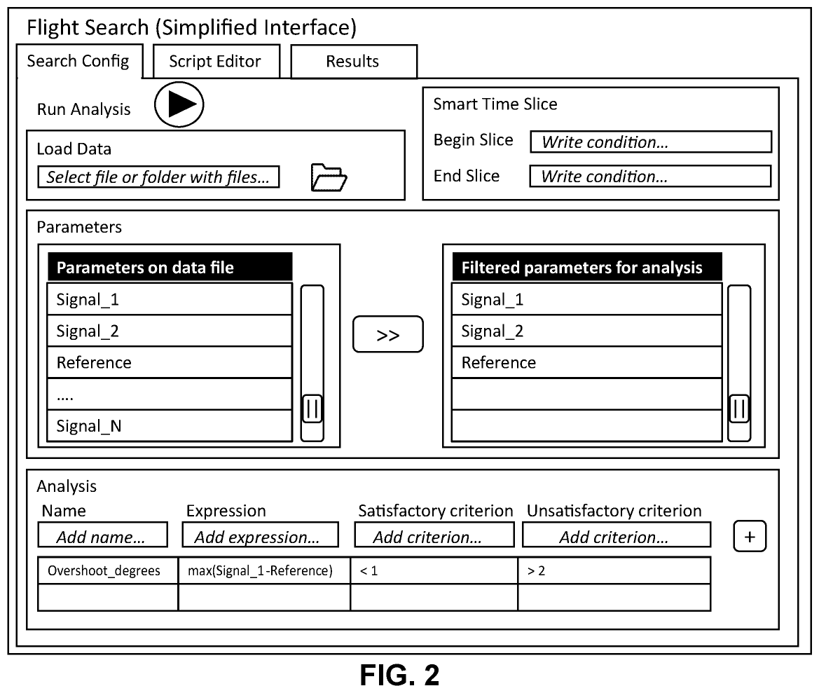

FIG. 2 shows an example interface including sections such as “Load Data” (to include the data to be analyzed), “Smart Time Slice” specification, “Parameters” specification, and “Analysis” input section.

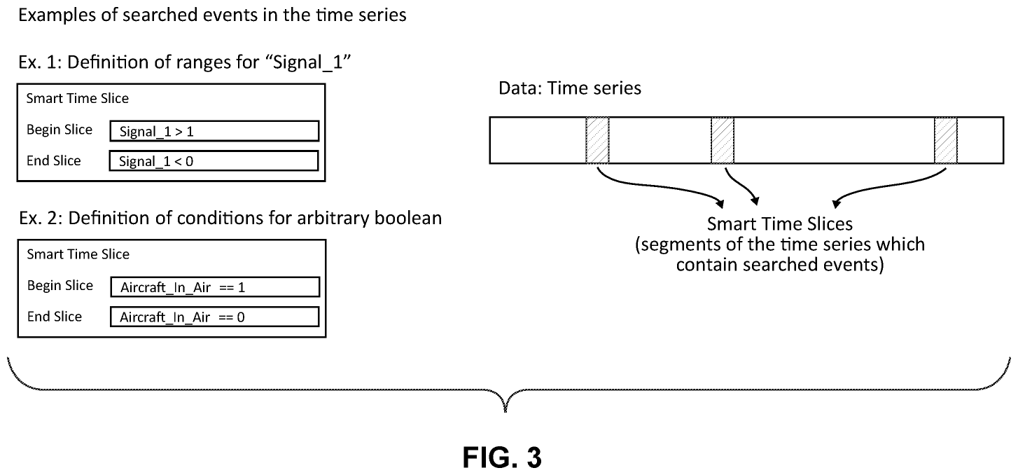

In a Search stage of the methodology, the user is requested to enter a statement called “Begin Slice”, that marks the beginning of the (signal-defined) event to be searched and a statement called “End Slice”, that marks the end of the (signal-defined) event. The search is applied several times, one for each file on the user database. FIG. 3 shows some examples on how to fill the requested fields on the interface for this stage. In this example, the “Parameters on data file” section on the lefthand side of the interface shows a scrollable set of time sequence parameters recorded in the data file. The user may select certain ones of the parameters (by clicking a “>>” button to add the selected parameters to the “Filtered Parameters for analysis” The user may then define two types of processing for analyzing the selected recorded time series parameters:
(1) “Begin Slice” and “End Slice” event conditions (see upper righthand portion of the user interface), and/or
(2) One or more “analysis” expressions with corresponding “Satisfactory criterion” and “Unsatisfactory Criterion”.
   For example “Begin Slice” and “End Slice” event conditions, as shown in FIG. 3 “Ex. 1”, one kind of event is to define time slices where the particular time-varying recorded “Signal_1” is greater than 1 up to the moment when “Signal_1” is lower than zero. As shown in FIG. 3 “Ex. 2”, another example of event is to find time slices where a recorded boolean state value “Aircraft In Air” becomes 1 up to the moment when “Aircraft In Air” changes to 0. Such search specifications can use boolean or other expressions based on a variety of different metadata markers marking the stored flat files. In some embodiments, the search can define multiple event conditions that need to exist (or not exist) simultaneously, e.g., signal >1 to signal <0 when Aircraft In Air is “true”.

FIG. 3 presents an example of selected output data, in the format of time series, for such event search results. The segments (slices) that comply with the searched events are shaded. These segments are called “Smart Time Slices”. The results of this stage are several data structures, each one containing the time series data present on the file already cut or divided to match the time span of an event found. Some time series data files may contain no time slices that correspond to a searched-for event, other time series data files may contain one time slice that corresponds to a searched-for event, and still other time series data files may contain more than one time slice that corresponds to a searched-for event. In example embodiments, smart time slices corresponding to searched-for events can have different lengths (periods)

In the analysis stage, the user is requested to specify one or more analysis to be applied in each of the found events. For each analysis, the user needs to enter the analysis name, an equation or other expression to be evaluated and a pass/fail criterion to be applied on the value resultant of the equation. As result of this stage, there is a table containing the results of all the equations for each event found. Equations can have various different forms such as max(Signal_1−Reference), which returns the maximum excursion of the signal “Signal_1” above the limit “Reference”.

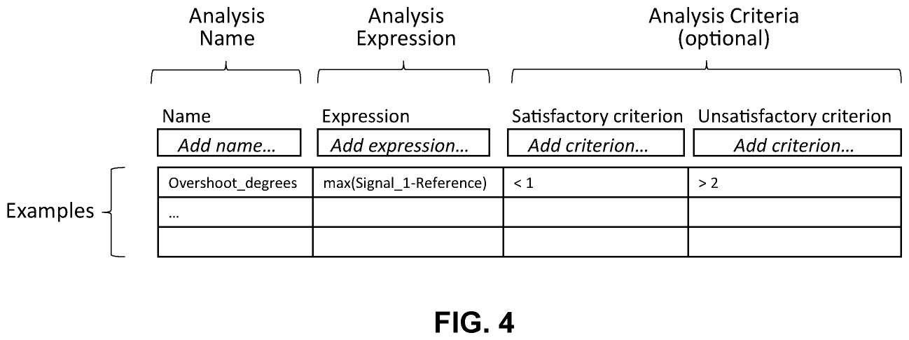

FIG. 4 shows an example on how the users fill the analysis fields on the interface. In this example, the interface provides various input fields, where the user can select to “build” an equation such as shown above. For example, FIG. 4 shows an example of analysis “Overshoot degrees”, given by the expression “max(Signal_1−Reference)”. The satisfactory criterion (optional) in this case is achieved if “max(Signal_1−Reference)” is lower than 1, within the time slice. The unsatisfactory criterion (optional) in this case is achieved if “max(Signal_1−Reference)” is greater than 2, within the time slice (i.e., the recorded time series signal being examined has overshot its reference value by more than a certain amount). Additional criteria, composed by user-defined expressions can be inserted on the interface of FIG. 4.

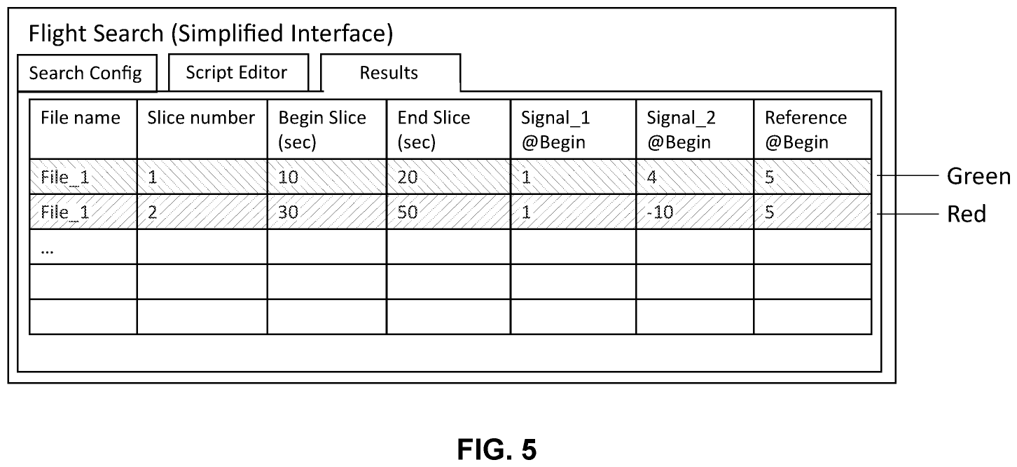

In the summarization stage, the table generated on the analysis stage is transported or exported to a spreadsheet file (see FIG. 5) with the user specified criteria used to color or shade the cells containing the results of the equations and images containing plots of specified parameters curves of each found event are created. In the example shown, both time slices containing satisfactory (green) analysis results and time slices containing unsatisfactory (red) analysis results are provided. In this example, each selected time slice in each file is indicated (moments of “Begin Slice” and “End Slice” pointers), as well as the values of filtered parameters for each time slice. Such values can be for example markers where selected parameters exist.

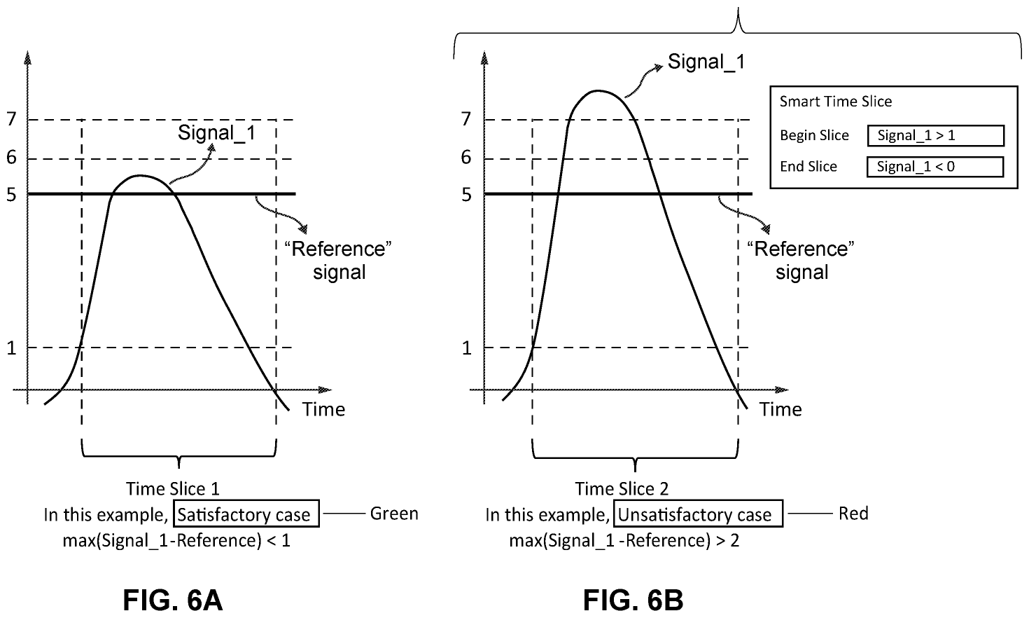

The integrated methodology has as inputs the information written by the user on the graphical interface and has as output a spreadsheet with the summary of the analysis results and the figures containing plots of the signals of interest, as shown in FIGS. 6A and 6B.

In order to produce the figures with the signals of interest, a file containing instructions to generate the curves and legends may be prepared a priori. Figures may be generated for each time slice (FIG. 6A, 6B). In this example, the FIG. 6A Time Slice 1 and the FIG. 6B Time Slice 2 are selected using the same criteria, i.e., the slice begins when the signal of interest exceeds 1 and ends when the signal of interest falls below zero. The additional analysis described above (maximum of difference between the signal of interest and a reference signal is less than one (satisfactory case) or is greater than 2 (unsatisfactory case) is applied over the duration of the smart time slice. Thus, the net effect of the two operations is to (a) locate all time slices defined between the signal rising above 1 and then falling to below zero, and (b) determine those time slices in which that same signal exhibits, within the duration of the smart time slice defined by (a), a particular kind of overshoot and which time slices do not have such overshoot. The analysis in this case is applied to the same signal(s) that defined the time slice begin and send, but in other embodiments could be applied to different signal(s) or a combination of the same signal(s) and different signal(s).

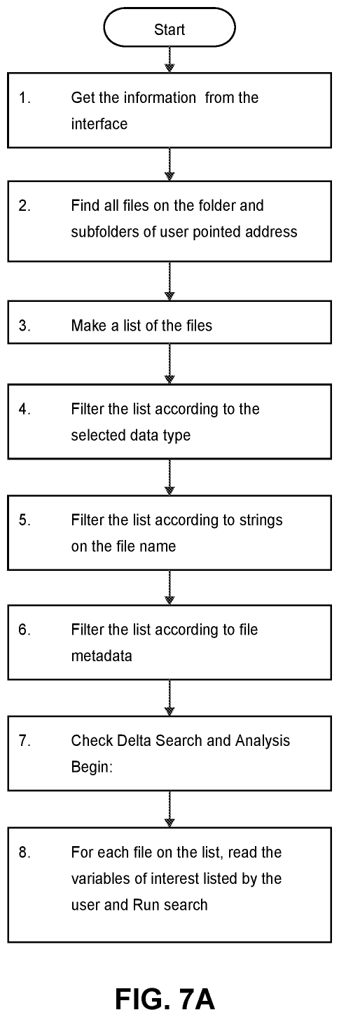

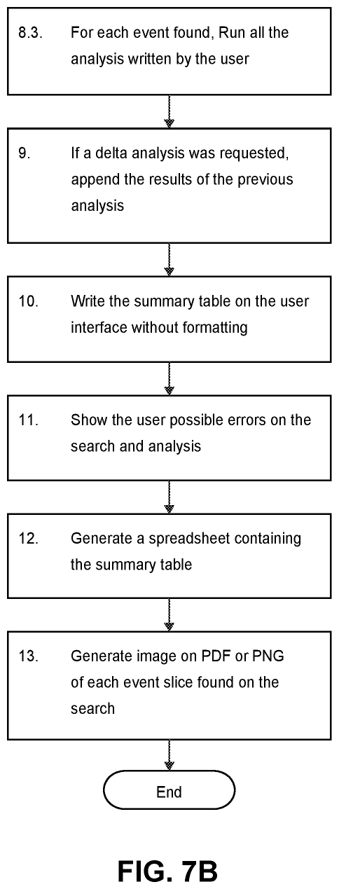

The following FIG. 7A, 7B show example steps of integration performed by the system 50 shown and described above, and in particular by processor(s) 210 executing instructions stored in the instruction memory 212:
1. Get the information from the interface: Here all the information written on the interface is transferred to the proper structure with the proper data type:
   1.1. Get data base address pointed by the user
   1.2. Get Smart Time Slice instructions written by the user (Begin slice, end slice)
   1.3. Get list of the variables to be read on each file
   1.4. Get the analysis names and equations to be made on each slice
   1.5. Get the pass/fail criteria for each analysis
2. Find all files on the folder and subfolders of user pointed address
3. Make a list of the files
4. Filter the list according to the selected data type
5. Filter the list according to strings on the file name
6. Filter the list according to file metadata
7. Check Delta Search and Analysis Begin: here an option is given to the user to reuse the results of the last search analysis and complement it with newly arrived files on the data base
   7.1. Get spreadsheet file generated on the last search
   7.2. Does the spreadsheet contain the same Smart Time Slice and Analysis instructions of the current search?
   7.3. If yes, read the name of the files already searched in the spreadsheet
   7.4. Filter out such names of the current files list
8. For each file on the list do:
   8.1. read the variables of interest listed by the user
   8.2. Run search
      8.2.1. Does the user instruction contain a customized function?
      8.2.2. If yes, include the function folder on the path
      8.2.3. Evaluate all the moments where the begin slice statement transitions from FALSE to TRUE, marking the beginning of the Search event with a timestamp
      8.2.4. Evaluate all the moments where the end slice statement transition from FALSE to TRUE, marking the ending of the Search event with a timestamp
      8.2.5. Is there more than a begin/end slice transition from FALSE to TRUE?
      8.2.6. Find and connect the pairs of begin and end slice markers to form the event time slices
      8.2.7. Make correction if the number of marked begins are different from the marked ends
      8.2.8. According to the user instructions for each connected slice, apply a time delta on the begin/end
   8.3. For each event found do:
      8.3.1. Run all the analysis written by the user
         8.3.1.1.1. Calculate the analysis equation
         8.3.1.1.2. Apply the specified pass/fail criteria on the equation result
         8.3.1.1.3. Append the name of the current file, number of the current slice, analysis name, equation result, criteria result of the current analysis to a table
9. If a delta analysis was requested, append the results of the previous analysis
10. Write the summary table on the user interface without formatting
11. Show the user possible errors on the search and analysis
12. Generate a spreadsheet containing the summary table
   12.1. Get the summary table written on the interface
   12.2. Break the summary table in several tables according to the user instruction of tab separation
   12.3. Build a table pointing the equation and criteria for each analysis
   12.4. Build spreadsheet file
   12.5. Format spreadsheet file lines width, column width, borders,
   12.6. Format spreadsheet file by painting the cells that contain analysis results that passed the criteria with green and the ones that failed the criteria with red
13. Generate image on PDF or PNG of each event slice found on the search
   13.1. For each file where slices were found do:
      13.1.1. For each found slice on the file do
         13.1.1.1. Build an image using all the users' selected signals to be plotted
         13.1.1.2. Put a zoom on the current slice
         13.1.1.3. Plot vertical marks to show where the slice begins and where it ends

The proposed computer-methodology can be applied to several engineering and science fields, being mostly agnostic about the field application itself. The only dependency of methodology is data to be composed of time series and be stored in flat files. For exemplification's sake, the methodology can be used on data obtained from simulation, tests or final product measurements of airplanes, cars, boats, or spaceships.

All patents and publications cited herein are incorporated by reference.

While the technology herein has been described in connection with exemplary illustrative non-limiting embodiments, the invention is not to be limited by the disclosure. The invention is intended to be defined by the claims and to cover all corresponding and equivalent arrangements whether or not specifically disclosed herein.

1. A computer method for analyzing time sequence signal data comprising:
receiving an event specification;
searching time sequenced data for time slices that meet the event specification;
analyzing a located time slice that meets the event specification to determine if it satisfies a criterion; and
generating a data structure that (a) indicates a portion of the time sequenced data that meets the event specification and (b) indicates whether or not the portion of the time sequenced data that meets the event specification satisfies the criterion.

2. The method of claim 1 wherein receiving comprises receiving user input specifying an event beginning and an event end.

3. The method of claim 1 wherein the event beginning and event end are specified by behavior of a signal within the time sequenced data.

4. The method of claim 1 wherein analyzing comprises testing whether a specified signal within the indicated portion of the time sequenced data satisfies the criterion.

5. The method of claim 4 wherein the criterion comprises characteristics of the signal over the duration of the portion.

6. The method of claim 5 wherein the characteristics comprise overshoot characteristics.

7. The method of claim 1 wherein the time sequenced data comprise a plurality of discrete data streams.

8. The method of claim 7 wherein the discrete data streams comprise airborne sensor outputs and aircraft system state data.

9. A computer system for analyzing time sequence data comprising a processor system configured to perform operations comprising:
receiving an event specification;
searching time sequenced data for time slices that meet the event specification;
analyzing a located time slice that meets the event specification to determine if it satisfies a criterion; and
generating a data structure that (a) indicates a portion of the time sequenced data that meets the event specification and (b) indicates whether or not the portion of the time sequenced data that meets the event specification satisfies the criterion.

10. The system of claim 9 wherein the receiving comprises receiving user input specifying an event beginning and an event end.

11. The system of claim 9 wherein the event beginning and event end are specified by behavior of a signal within the time sequenced data.

12. The system of claim 9 wherein analyzing comprises testing whether a specified signal within the indicated portion of the time sequenced data satisfies the criterion.

13. The system of claim 12 wherein the criterion comprises characteristics of the signal over the duration of the portion.

14. The system of claim 13 wherein the characteristics comprise overshoot characteristics.

15. The system of claim 9 wherein the time sequenced data comprise a plurality of discrete data streams.

16. The system of claim 15 wherein the discrete data streams comprise airborne sensor outputs and aircraft system state data.

17. The system of claim 9 wherein the processor system is further configured to provide a human user interface that enables a user to input the event specification and the criterion.
